(19) United States
(12) Patent Application Publication
(10) Pub. No.: US 2010/0274675 A1
(43) Pub. Date: Oct. 28, 2010

(54) WEB PAGE RETRIEVAL AND ADVERTISEMENT METHOD

(76) Inventor: Keun-Woo Lee, Seoul (KR)

Correspondence Address: KNOBBE MARTENS OLSON & BEAR LLP, 2040 MAIN STREET, FOURTEENTH FLOOR, IRVINE, CA, 92614, US

(21) Appl. No.: 12/832,038

(22) Filed: Jul. 7, 2010

Related U.S. Application Data
(63) Continuation of application No. 10/343,310, filed on Jan. 28, 2003, now abandoned.

(30) Foreign Application Priority Data
Jul. 28, 2000 (KR) 10-2000-43591

(51) Int. Cl. G06Q 30/00; G06F 17/30

(52) U.S. Cl. 705/14.73; 707/769; 707/E17.014

(57) ABSTRACT

Disclosed is a computer-implemented method of running an Internet-based service. The method involves receiving a request for a code that identifies one or more web pages, issuing a non-URL code for the advertiser to post on an off-line advertisement in reply to the request, posting an off-line advertisement including the non-URL code, a person's seeing the advertisement, the person's submitting the issue code on a mobile telecommunication device without opening a web page on the mobile telecommunication device to a server, the server's searching for an Internet address of a web page associated with the issued code, the server's sending to the mobile telecommunication device the Internet address to the mobile telecommunication device, and opening the web page on the mobile telecommunication device using the Internet address without any user input of the Internet address on the mobile telecommunication device.

### CROSS-REFERENCE TO RELATED PATENT APPLICATIONS

This application is a continuation application of U.S. patent application Ser. No. 10/343,310, filed based on PCT Application No. PCT/KR01/01287, filed Jul. 28, 2001 and published in English as WO 02/15070 A1 on Feb. 21, 2002, which claims priority to Korean Patent Application No. 10-2000-43591 filed Jul. 28, 2000. This application incorporates herein by reference U.S. patent application Ser. No. 10/343,310, PCT Application No. PCT/KR01/01287 and Korean Patent Application No. 10-2000-43591 in their entirety.

### TECHNICAL FIELD

The present invention relates to methods for retrieving and advertising web pages using a issue number in the internet, more particularly to a method by which advertising producers register web pages and insert the issue number corresponding to the registration on the advertising media so that users can get the issue number to thereby make a connection to the web pages through client terminals.

### BACKGROUND

Even with the internet prevailing, a person still gets a lot of information offline through the daily life. Perhaps, the information that a person obtains by conventional media such as catalogues, magazines, newspapers, posters and signboards surpasses that collected by searching over the computer network such as the internet.

Information retrieval over the network is accomplished by inputting already known Uniform Resource Location (URL) or by the keyword search in the portal site. In the above methods, a user should know the accurate address of URL of desired web site, or the keyword search may provide a huge pile of list, which makes rapid and accurate retrieval of information difficult.

Assuming that a person of actual life on walking street looks at the poster of a play with Jonathan Livingston Seagal, he keeps the title and the playhouse in mind. Then, if he wishes to buy the ticket in advance, he may retrieve the relevant web site to get information on details of the play and to buy the ticket. At this time, he may search the portal site, preferably specialized in a play, by inputting the title of the play or the playhouse. To get the accurate information on the play, the relevant information on the play should be provided in the portal site as searching data. Otherwise, he should surf over the internet and search directly the information.

First of all, to obtain the information for the user in the portal site, the URL of the play or playhouse should be previously registered in the site, and the promoter of the play should upload detailed information on the play in the form of web pages. Even in the above case, if the user retrieves by the keyword “Jonathan Livingston Seagal” over the whole web pages, he should select the desired information from a lot of useless information, and further he may obtain the desired information after conducting many steps.

Also, as the measures that the promoter of the play can take for the advertisement, typical means conducted offline in the real life such as publication and distribution of a poster and a catalogue and network-based means such as making and posting a home page with detailed information on the play-specialized portal site may be adopted.

As another aggressive advertising method, the URL only for the play may be registered and printed on the poster. However, the method needs web hosting and registration of domain name, which would be cumbersome. Generally, the play promoter is likely to be passive in the advertisement of computer-based network, unless he registers particular domain for the play and web pages through the web server. Perhaps, he might wish the play portal site to register his play on the web page, or the title of the play to be listed on the top page of the searching site.

Accordingly, the conventional advertising method requires a lot of expenses and efforts to satisfy both the advertising producer and the user.

### SUMMARY

One aspect of the present invention is designed to overcome the problems of the prior art. Another aspect of the invention provides a method for retrieving and advertising web pages, which provides effective and inexpensive advertising means to the advertisement producer, and which provides means for obtaining necessary information easily to the user.

Another aspect of the present invention provides a method for simplifying the processes of distribution and gain of information between advertisement producers and users. To provide such a method, the advertisement producer connects to a web site of the present invention, receives the issue number to be used in advertisement, and registers web pages relating to the issue number. Then, the advertisement producer posts the issue number on the advertisement media to be distributed. The user who recognizes the issue number keeps the issue number in his mind or inputs the number in a mobile telecommunication device, and then connects to the web site through the user's terminal to take a view of the web page in order to obtain the detailed information for purchase or pre-purchase.

### BRIEF DESCRIPTION OF THE DRAWINGS

These and other features, aspects, and advantages of embodiments of the present invention will be more fully described in the following detailed description, taken accompanying drawings. In the drawings:

FIG. 1 shows configuration of network in which embodiments of the present invention are accomplished.

FIG. 2 is a diagram showing a producer, an issue server and a user taking steps according to one embodiment of the present invention.

FIG. 3 is a diagram showing a producer, an issue server and a user taking steps according to another embodiment of the present invention.

FIG. 4 is a flow chart illustrating that the issue server issues an issue number according to one embodiment.

FIG. 5 is a flow chart illustrating that the issue server issues an issue number according to another embodiment.

FIG. 6 is a flow chart illustrating that the user inputs the issue number using a mobile telecommunication device or an internet terminal according to one embodiment.

FIG. 7 shows configuration of the present invention consisting of a user, a mobile telecommunication device and an issue server.

FIG. 8 is a flow chart illustrating that the user inputs the issue number using a mobile telecommunication device or an internet terminal according to another embodiment.

FIG. 9 shows an example of display of a web page for user login.

FIG. 10 shows an embodiment in which a web page list is displayed on user's monitor.

FIG. 11 is a diagram illustrating inter-connection of direct payment system on the linked web page.

### DETAILED DESCRIPTION OF CERTAIN EMBODIMENTS

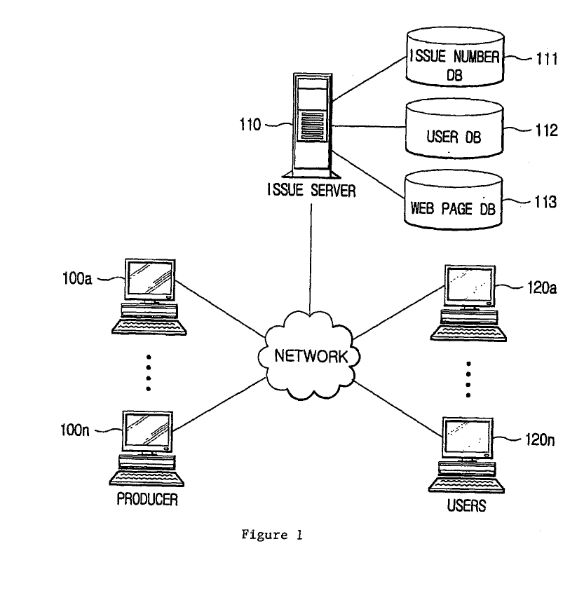

Hereinafter, embodiments of the present invention will be described in detail with reference to the accompanying drawings. FIG. 1 shows configuration of network in which the present invention is accomplished.

In FIG. 1, producers 100a through 100n are those who make a plan of advertisement such as performance producers, advertisement producers of companies and small-sized businessman. The producers connect to an issue server 100 of the present invention to receive the issue number, and register a web page linked to their advertisement site or home pages on the issue server 100.

In doing so, the issue server 110 has an issuing means (not shown) for issuing and administrating the number, and database including a issue number DB 111 for administration of the issue number, user DB 112 for administration of users and web page DB 113 storing web pages registered by the producers 110a through 100n.

Users 120a through 120n connect to the issue server 110 using the issue number obtained from the advertisement media distributed by the producers 100a through 100n to thereby get various information from web pages registered by the producers.

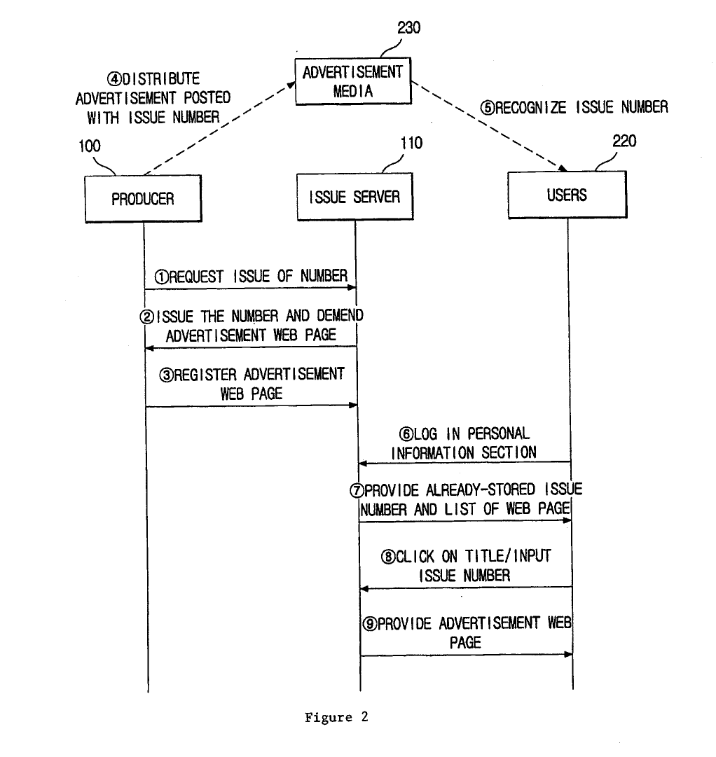

FIG. 2 is a diagram showing a producer, an issue server and a user taking steps according to one embodiment of the present invention, particularly, in case that the user is registered as a member of the issue server.

First, the producer 100 connects to the issue server 110 to register web pages for advertisement and requests the issue number to be posted on the advertisement media (\textcircled{1}). Then, the issue server 110 issues the issue number and requests a web page for advertisement using the number (\textcircled{2}).

Here, the issue number is given to the producers 100 in the form of, for example, “RT-No. 4567981”. Namely, the Issue number may be expressed in the form of numeral array that the users can easily input or memorize. The producer transmits a web page for which the issue number is to be used for advertisement to the issue server 110 and enrolls the web page on the issue server 110 so that the web page is recorded in the web page DB 113 (\textcircled{3}). Also, the advertisement producer posts the issue number on the advertisement media 230 such as newspapers, magazines and catalogues or the like to be distributed off-line (\textcircled{4}).

Then, the user 220 obtains the issue number from the advertisement media 230 off-line (\textcircled{5}), and connects to the issue server 110 by his mobile telecommunication device. The user makes a login to his personal information section and stores the issue number therein. The personal information section is separate recording space that is provided by the issue server 110 for the user.

As the above, the user may store several issue numbers on his personal information section. When the user connects to issue server 110 using his mobile telecommunication device and makes a login to the personal information section (\textcircled{6}), the issue server provides already-stored issue number and list of web pages (\textcircled{7}). Then, the user views the list and clicks on the desired title (\textcircled{8}), so that the issue server 110 retrieves the selected web page from the web page DB 113 to transmit the same to the mobile telecommunication device (\textcircled{9}). Accordingly, the user can obtain the desired information and enjoy the service of pre-purchase and purchase that the issue server provides.

In the present embodiment, the user may directly input the issue number to retrieve the desired site after the connection to the issue server 110. In this case, the issue server 110 gets the information of web page corresponding to the issue number that is input and transmitted from the user's mobile telecommunication device from the issue number DB 111, and retrieves the corresponding web page from the web page DB 113 and transmits the same to the mobile telecommunication device.

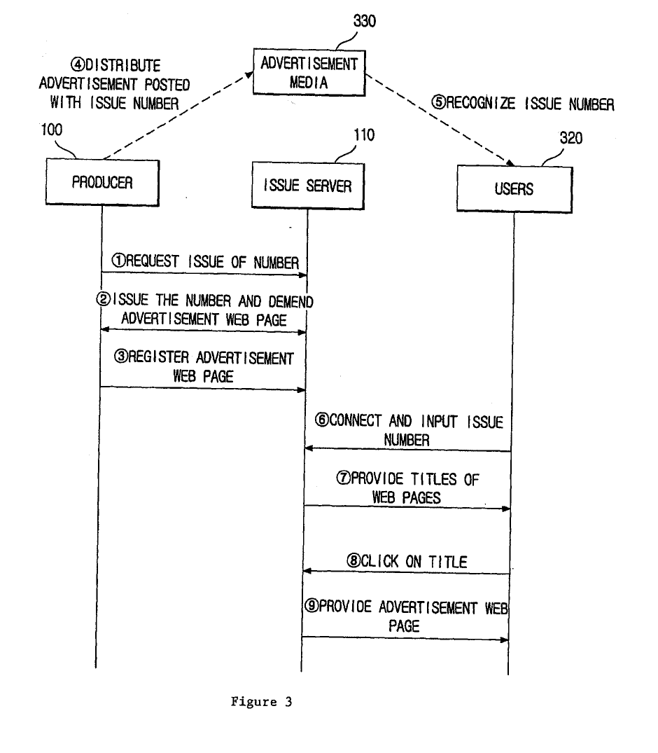

FIG. 3 is a diagram illustrating that the producer, the issue server and the user take steps according to another embodiment of the present invention. Particularly, FIG. 3 is different from FIG. 2 in that the users are not members of the service by the issue server.

First, the producer 100 connects to the issue sever 110 and demands the issue of the number to register a web page for advertisement (1). In response to the demand, the issue server 110 issues the issue number and requests the web page to be linked with the issue number for advertisement (2). Here, the issue number is given to the producers 100 in the form of, for example, “RT-No. 4567981” as described in the embodiment of FIG. 2. the producer registers the web page for advertisement corresponding to the issue number on the issue server 110 (3). Also, the advertisement producer posts the issue number on the advertisement media 330 such as newspapers, magazines and catalogues or the like to be distributed off-line (4).

Then, the user 320 obtains the issue number from the advertisement media 330 off-line (5), and connects to the issue server 110 by his mobile telecommunication device to input the issue number thereto (6). Then, the issue server gets the information of web page corresponding to the issue number that is transmitted from the mobile telecommunication device from the issue number DB 111, and provides the corresponding title to the user (7). Subsequently, the user clicks on the desired title (8), so that the issue server 110 provides the corresponding web page for advertisement to the mobile telecommunication device. Accordingly, the user can obtain the desired information and enjoy the service of pre-purchase and purchase that the issue server provides.

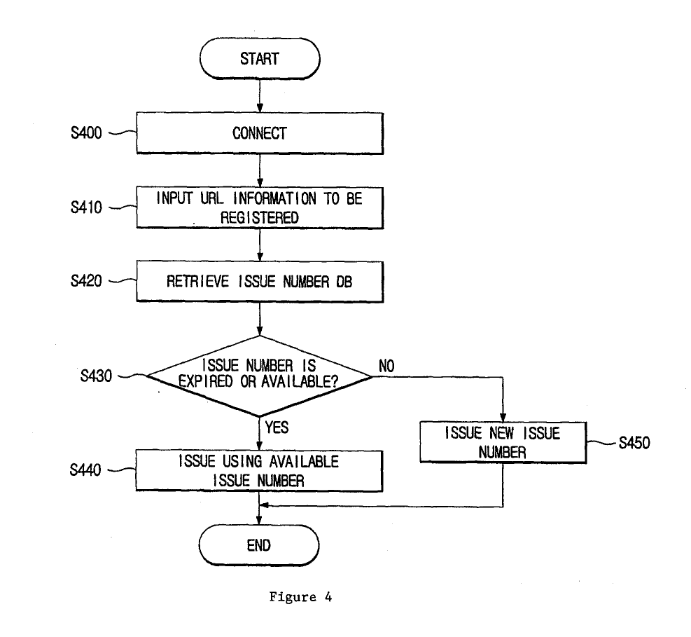

FIG. 4 is a flow chart illustrating that the issue server issues an issue number according to one embodiment.

The producer 100 in FIG. 1 connects to the issue server 110 (step S400), and inputs URL information to be registered (step S410). A numbering means of the issue server retrieves the issue number DB to issue the number (step S420). At this time, the numbering means checks whether the issue number expired or an available issue number exists (step S430). If the available issue number exists, the numbering means issues the issue number (step S440). If there are not available issue numbers, the numbering means issues a new issue number (step S450).

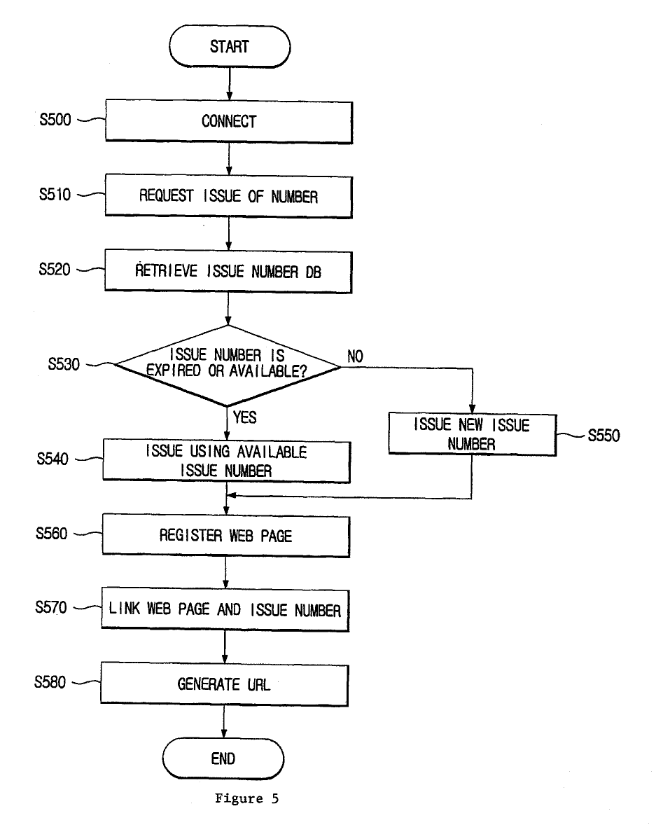

FIG. 5 is a flow chart showing the procedure of issuing an issue number in the issue server according to another embodiment.

The producer 100 in FIG. 1 connects to the issue server 110 (step S500), and request for the issue of number (step S510). A numbering means of the issue server retrieves the issue number DB to issue the number (step S520). At this time, the numbering means checks whether the issue numbers expire or the available issue numbers exist (step S530). If the available issue number exists, the numbering means issues the issue number (step S540). Otherwise, if there are not available issue numbers, the numbering means issues a new issue number (step S550). When the producer transmit a web page corresponding to the issued number to the issue server 110 to be registered (step S560), the issue server interlinks the transmitted web page and the issue number to thereby make a renewal of the issue number DB (step S570) and store the web page on the web page DB (step S580).

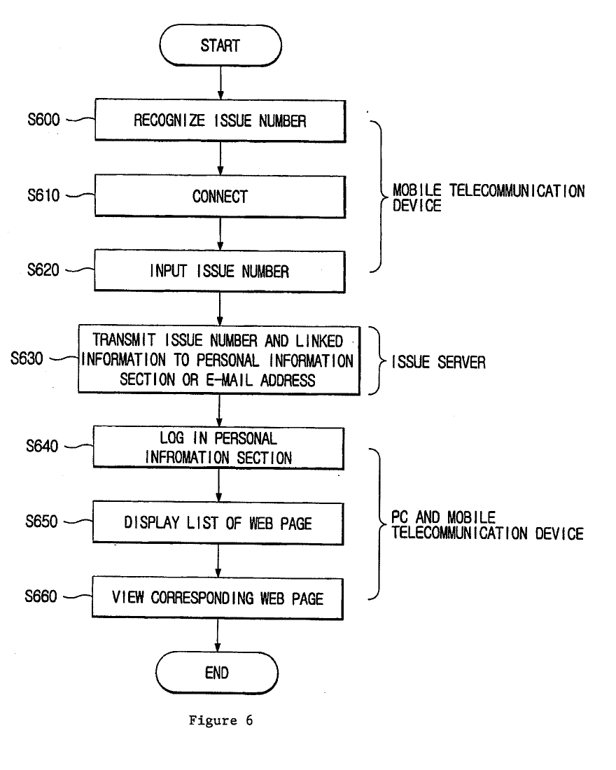

FIG. 6 is a flow chart illustrating that the user connects to the issue server using a mobile telecommunication device to input the issue number and retrieve the web page according to one embodiment.

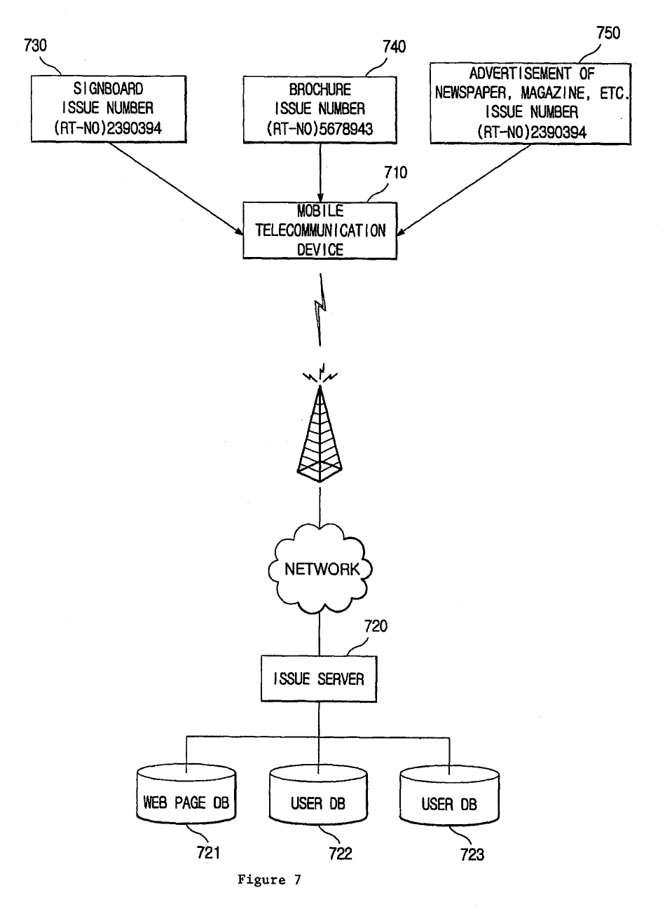

The user recognizes the issue number posted on the advertisement media (FIG. 7) in the real life (step S600) to then connect the issue server using a hand-held phone or PDA (step S610). The user input the issue number by means of input buttons of the mobile telecommunication device (step S620).

After the completion of input of the issue number, the issue server transmits the issue number together with information of the web page together with the corresponding issue number to the user's personal information section (step S630).

Here, the step S600 through S630 may be done repeatedly. That is, several issue numbers obtained from the advertisement media can be input.

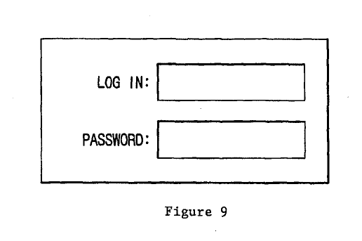

Then, the user connects again to the issue server by his mobile telecommunication device to make a login to his personal information section (step S640). At the same time, the issue number and list of web pages are displayed on the user's monitor as shown in FIG. 9 (step S650). When the user chooses one of the listed web pages, the issue server 110 provides the web page to the mobile telecommunication device. Accordingly, the user can retrieve desired information, or make a pre-purchase or payment (step S660).

FIG. 7 shows a configuration of network between the user, the mobile telecommunication and the issue server, wherein the reference numerals labeled differently from in FIG. 1 for convenience.

The user may input and transmit the issue number 700 obtained form the advertisement media, for example, a printed medium 750 such as a signboard 730, a brochure 740, a newspaper and magazine to the issue server 720 using the mobile telecommunication device 710. The issue server 720 is provided with a web page DB 721, a user DB 722, and an issue number DB 723 acting the same function as in FIG. 1.

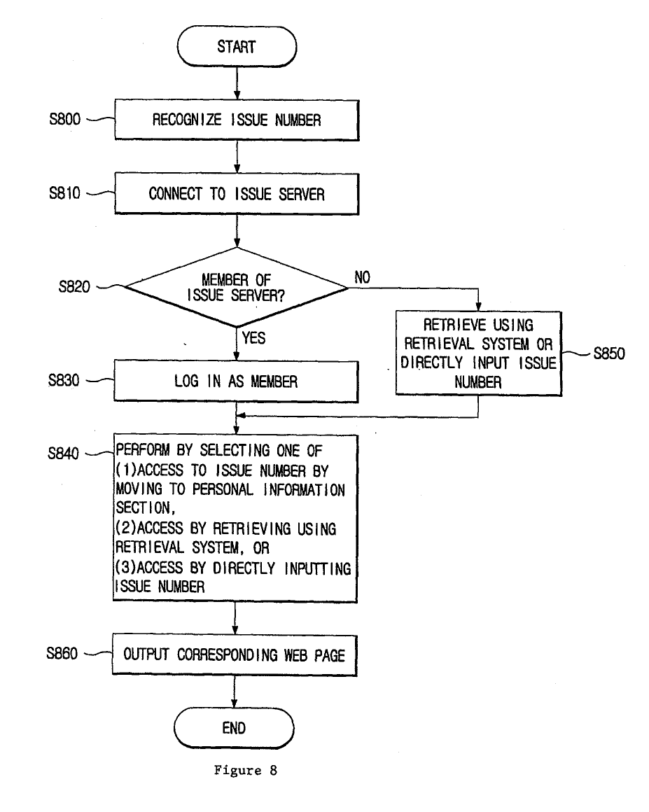

FIG. 8 is a flow chart illustrating that the user connects to the issue server using a mobile telecommunication device to input the issue number and retrieve the web page according to another embodiment.

The user recognizes the issue number posted on the advertisement media (FIG. 7) in the real life (step S800) to then connect the issue server using a user terminal such as a hand-held phone or PDA (step S810). The issue server determines whether the user is a member of the issue server (step S820). If the user is a member, the server asks the user to log in as a member (step S830). If the user is not a member, the issue server retrieves using a retrieval system or allows the user to directly input an issue number (step S850).

The issue server performs one of the following: 1) allowing the user to access an issue number by moving to a personal information section, 2) allowing the user to access an issue number via a retrieval system or 3) allowing the user to access by directly inputting an issue number (step S840). The server outputs a web page corresponding to the input issue number (step S860).

FIG. 9 shows an example of display of a web page for user login. The user can access to the personal information section by the above user login.

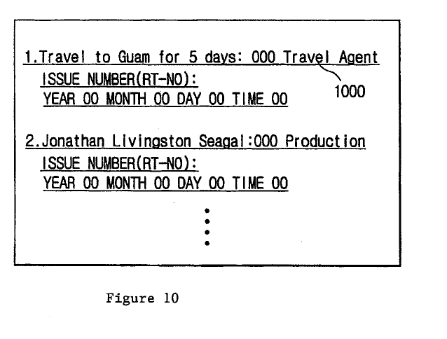

FIG. 10 shows an embodiment in which a web page list is displayed on user's monitor.

Here, when the user clicks on the desired web page to thereby access the linked web page directly. For example, the user chooses the title of “travel to Guam 5 days: ooo travel agent” (1000), the web page linked with the issue number is provided to the mobile telecommunication device from the issue server.

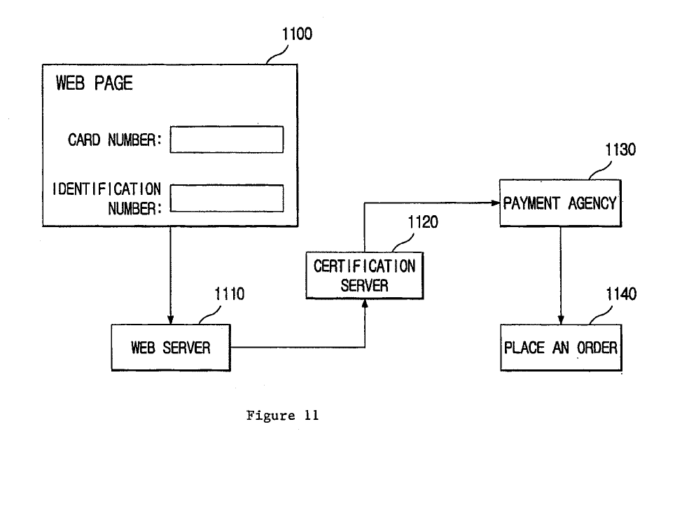

FIG. 11 is a diagram illustrating direct payment on the linked web page.

If the user wishes to make payment for pre-purchase or purchase on the web page 1100, the user's payment information such as the card number, address, name and identification number is transmitted via the web server 1110 to a certification server 1120. Then, the certification server transmits the information to the payment agency 1130 to thereby place an order 1140.

The present invention is not intended to be limited to the embodiment herein, but various modifications and changes will be readily apparent to those skilled in the art within the scope of the present invention, which is set forth in the appended claims.

According to the present invention, the producer can distribute the issue number through the advertisement media, which enables inexpensive and effective advertisement.

Also, the user can easily access to the issue server on walking outdoors using mobile telecommunication devices to obtain desired information or make a pre-purchase/purchase, which decreases the expenses and time for the user.

What is claimed is:

1. A computer-implemented method of running an Internet-based service, the method comprising:
receiving, by a service from an advertiser, a request for a code that identifies one or more web pages;
issuing, by the service to the advertiser, a non-URL code for the advertiser to post on an off-line advertisement;
receiving, by the service, a submission of the issued code from a mobile telecommunication device, wherein the submission of the issued code is made without opening an interim web page on the mobile telecommunication device;
upon receipt of the submission, searching in a database, by the service, for one or more network accessible addresses of the one or more web pages associated with the issued code; and
sending, by the service, to the mobile telecommunication device, the one or more network accessible addresses so as to enable the mobile telecommunication device to open the one or more web pages without any user input of a URL of the one or more web pages on the mobile telecommunication device,
wherein at least one of receiving a request, issuing the non-URL code, receiving the submission, searching for one or more network accessible addresses and sending the one or more network accessible addresses is performed by one or more computers of the service.

2. The method of claim 1, wherein issuing comprises determining whether a code is expired or available.

3. The method of claim 1, wherein the issued code comprises a combination of one or more of numbers and one or more letters.

4. The method of claim 1, further comprising:
receiving, from the advertiser, a request for renewal of using the issued code for locating or opening the web page; and
sending, to the advertiser, an approval for renewal of using the issued code.

5. The method of claim 1, wherein the off-line advertisement is placed in a medium selected from the group consisting of a poster, a signboard, a catalog, a newspaper and a magazine.

6. The method of claim 1, further comprising:
maintaining a personal information space of a user on a website; and
storing a plurality of codes including the issued code in the personal space of the user in reply to a request from the user.

7. The method of claim 36, wherein the issued code comprises a sequence of numbers.

8. The method of claim 36, wherein the mobile telecommunication device comprises a mobile phone or a PDA.

9. A computer-implemented method of opening a web page by a user, the method comprising:
obtaining, from an off-line advertisement, a non-URL code that is indicated in the off-line advertisement as used for accessing the content, wherein the code is an alphanumerical sequence;
sending the non-URL code from a mobile telecommunication device to a server without any input of a URL on the mobile telecommunication device for submitting the non-URL code;
in response to sending the non-URL code, receiving, at the mobile telecommunication device, one or more network accessible addresses for opening one or more web pages;
opening, at the mobile telecommunication device, the one or more web pages using the one or more network accessible addresses without any user input of a URL of the one or more web pages on the mobile telecommunication device; and
receiving, at the mobile telecommunication device, a content associated with the off-line advertisement.

10. The method of claim 9, wherein the mobile telecommunication device is a mobile phone or a PDA.

11. The method of claim 9, wherein the off-line advertisement is contained in a medium selected from the group consisting of a poster, a signboard, a catalog, a newspaper and a magazine.

12. The method of claim 9, wherein the non-URL code further comprises at least one letter.

13. The method of claim 9, wherein the information comprises an internet address of the associated web page.

14. The method of claim 9, wherein the service web page is associated with the server.
